(19) United States
(12) Patent Application Publication
(10) Pub. No.: US 2016/0088869 A1
(43) Pub. Date: Mar. 31, 2016

(54) METHOD FOR TREATING A FOOD PRODUCT AND A TREATED FOOD PRODUCT

(71) Applicant: STORA ENSO OYJ, Helsinki (FI)

(72) Inventors: Martin Haggblom, Helsinki (FI); Jan-Erik Nordstrom, Nacka (SE)

(21) Appl. No.: 14/786,730

(22) PCT Filed: Apr. 23, 2014
(86) PCT No.: PCT/IB2014/060944

§ 371 Date: Oct. 23, 2015

(30) Foreign Application Priority Data
Apr. 26, 2013 (SE) 1300307-4

(51) Int. Cl. A23L 3/3562

(52) U.S. Cl. CPC A23L 3/3562; A23V 2002/00

(57) ABSTRACT

The present invention relates to a method for treating a food product in order to preserve the product wherein the food product is treated with a solution comprising a nanofibrillated polysaccharide. The invention further relates to a food product being treated with a solution comprising a nanofibrillated polysaccharide.

### FIELD OF THE INVENTION

The present invention relates to a method for treatment of a food product with a solution comprising a nanofibrillated polysaccharide. The invention further relates to a food product being treated according to the method.

### BACKGROUND

Within the food industry there is an ongoing struggle to increase the shelf life of fresh food products, i.e. perishables such as meat, fish, fruit and vegetables. Today there exists many different ways to improve the shelf life of food products.

One way is to treat the food product with specific chemicals, e.g. preservatives or antioxidants that prevents microorganism growth and thus has a preservative effect on the food product. However, not all food products are suitable for chemical treatment. Another disadvantage is that the long term effect and the accumulation of the chemicals in the human body are being questioned. Furthermore, consumers want other more natural choices.

Another way to preserve food products is to improve the package in which the product is being stored. It can for example be done by the use of barrier packages that works as a barrier against, for example oxygen or moisture, controlling and extending the shelf life of the food product. It is also possible to modify the atmosphere in which the product is packed, e.g. by the use of inert gases, in order to prevent oxygen rich air from oxidizing the food product and thus extend the shelf life of the product. However, the greatest shortcoming of food packaging is the reliability of the barrier properties of the package. A package might be easily damaged during transportation and/or use and this might lead to unsatisfying barrier properties, leak of inert gas and even impurities through the package to the product. Another disadvantage with current packages is that the protective polymer or plastic components, such as plasticizers, of the package have been demonstrated to migrate from the package onto the packed food product.

There is thus a need for an improved method for the preservation of food products.

### SUMMARY OF THE INVENTION

The main objects of the present invention are to provide an improved method for preserving food products while providing a preserved food product.

These objects and other advantages are achieved by the method according to claim 1 and the product according to claim 13. The present invention relates to a method for treating a food product wherein the food product is treated with a solution comprising a nanofibrillated polysaccharide in at least one step whereby the shelf life of the food product is increased. It has been found that the treatment of a food product with nanofibrillated polysaccharide will reduce the degradation of the food product.

The nanofibrillated polysaccharide is preferably microfibrillated cellulose (MFC). It is preferred to treat the food product with MFC in order to preserve the treated food product because it is an environmental friendly product that has shown to be able to preserve food products effectively and efficiently.

It is also possible that the solution comprises both microfibrillated cellulose and cellulosic gum, or microfibrillated cellulose (MFC) and starch. It has been shown that the treatment of a food product with either of these solutions results in resistance against degeneration.

It is also possible that the solution also comprises amphiphiles, such as lecithin. Solutions containing amphiphiles are of relevance for making protective solutions for fatty food products. It has been shown that the combination of nanofibrillated polysaccharide, preferably microfibrillated cellulose and lecithin will give fat containing food products good protection.

The solution comprising a nanofibrillated polysaccharide is preferable sprayed onto the surface of the food product. By adding the solution by the aid of spraying it is possible to add the desired amount of nanofibrillated polysaccharide to the surface of the food product in a fast and efficient way.

The food product may be soaked in a solution comprising a nanofibrillated polysaccharide. In some cases, it may be advantageous to soak the entire food product in the solution comprising a nanofibrillated polysaccharide. The food product may be soaked in the solution comprising a nanofibrillated polysaccharide for a period of 1 second to at least 48 hours. The duration of soak time is dependent on the amount of nanofibrillated polysaccharide coverage required to add sufficient preservation properties to the food product.

It may be preferred to treat the food product with a solution comprising a nanofibrillated polysaccharide in more than one step, thus increasing the amount of nanofibrillated polysaccharide added to the product. It is possible to add the solutions in more than one step in different manners, preferably by the use of spraying, brushing and/or soaking of the product with the solutions.

The solution comprising a nanofibrillated polysaccharide preferably has a solid content of 0.01-10% by weight. Depending on how the treatment with the solution comprising a nanofibrillated polysaccharide is done, e.g. by spraying, brushing or soaking, the solid content of the solution may vary.

The nanofibrillated polysaccharide of the solution may be produced at least partly by enzymatic treatment of cellulosic fibers. If the nanofibrillated polysaccharide is microfibrillated cellulose (MFC), the MFC of the solution is preferable produced by partly enzymatic treatment. During the production of MFC with the aid of enzymes, the cellulosic fibers and fibrils may be decomposed, released or modified while finally forming MFC.

The MFC of the solution preferably has a diameter of between 5-200 nm. It has been shown that MFC within the mentioned diameter has improved film forming properties after drying of the treated product and thereby highly impermeable barrier properties. Treatment with a solution comprising MFC with the mentioned diameter will thus give the treated food product an improved resistance which will reduce the degradation of the food product.

The solution comprising a nanofibrillated polysaccharide may also comprise an additive with preserving properties. In this way it is possible further improve the shelf life of the product.

The solution comprising a nanofibrillated polysaccharide may also comprise seasoning. In this way it is possible to incorporate seasonings to the surface of the product in an improved way.

The invention further relates to a food product that has been treated with a solution comprising a nanofibrillated polysaccharide in order to preserve the food product. It has been shown that a food product comprising a nanofibrillated polysaccharide has increased resistance against microorganism growth as well as decomposition increasing the shelf life of the product.

The product has preferably been treated with a solution comprising microfibrillated cellulose (MFC), i.e. the food product comprises microfibrillated cellulose (MFC) which will preserve the food product.

The product has preferably been treated with a solution that comprises microfibrillated cellulose and cellulose gum or starch, i.e. the food product co microfibrillated cellulose (MFC) and cellulose gum or microfibrillated cellulose (MFC) and starch. It has been shown that the combination of MFC and cellulose gum or MFC and starch has improved film forming properties which will give the product improved preservation properties.

It is also possible that the solution also comprises amphiphiles, such as lecithin. Solutions containing amphiphiles are of relevance for making protective solutions for fatty food products. It has been shown that the combination of nanofibrillated polysaccharide, preferably microfibrillated cellulose and lecithin will give fat containing food products good protection.

The food product preferably comprises nanofibrillated polysaccharide in an amount of 0.15-50 g/m². The amount of nanofibrillated polysaccharide used during treatment may vary with consideration of the type of food product being treated and the preservation properties desired.

The food product preferably comprises at least one nanofibrillated polysaccharide film located on the surface of the food product. It is preferred that the at least one nanofibrillated polysaccharide layer covers at least a part of the surface of the food product.

The food product preferably comprises more than one nanofibrillated polysaccharide layers located on the surface of the food product. By treating the food product with a solution comprising nanofibrillated polysaccharide in more than one step, more than one layer of nanofibrillated polysacccharides are formed on the surface of the product. It is thus possible to provide the product with multiple layers of nanofibrillated polysaccharides in order to improve the shelf life of the product.

It is preferred that at least one of the nanofibrillated polysaccharide layers of the product is a barrier. The barrier is preferably a barrier against oxygen, i.e. giving the food product a protection against oxygen degeneration.

The at least one nanofibrillated polysaccharide layer preferably has a thickness of above 1 μm. Depending on the product as well as the end use, the thickness of the at least one layer of nanofibrillated polysaccharide may vary. When the product comprises more than one layer of nanofibrillated polysaccharides the combined thickness of the layers should preferably be above 1 μm.

It is preferred that the at least one of the nanofibrillated polysaccharide layer further comprises an additive, e.g. a preservative and/or antioxidant, with preserving properties. It is thus possible to further increase the shelf life of the product by adding an additive with preserving properties, such as a preservative or antioxidant.

It is also possible that at least one of the nanofibrillated polysaccharide layers further comprises a seasoning. By adding seasonings to the solution comprising a nanofibrillated polysaccharide, the seasonings will thus be incorporated in the at least one nanofibrillated polysaccharide layer located on the surface of the product.

### DETAILED DESCRIPTION

It has been found that by treating a food product with a solution comprising a nanofibrillated polysaccharide, preferably microfibrillated cellulose (MFC), the degradation and drying of the treated food product is reduced. Thus, the treatment of a solution comprising a nanofibrillated polysaccharide will preserve the food product and prolongs its shelf life. It has also been shown that food products being cooked at elevated temperatures, for example in an oven or in a frying pan, have improved juiciness and tenderness compared to food products not being treated according to the invention.

### Definition of Nanofibrillated Polysaccharide

This definition includes bacterial cellulose or nanocellulose spun with either traditional spinning techniques or with electrostatic spinning. In these cases, the material is preferably a polysaccharide but not limited to solely a polysaccharide. A polysaccharide can be e.g. starch, protein, cellulose derivatives etc.

Also microfibrillated cellulose as defined more in detail below is included in this definition.

### Definition of Microfibrillated Cellulose

The microfibrillated cellulose (MFC) is also known as nanocellulose. It is a material typically made from wood cellulose fibers, from both hardwood or softwood fibers. It can also be made from microbial sources, e.g. seaweed fermented fibers, agricultural fibers such as wheat straw pulp, bamboo or other non-wood fiber sources. In microfibrillated cellulose the individual microfibrils have been partly or totally detached from each other. A microfibrillated cellulose fibril is normally very thin (e.g. a width of 5-200 nm) and the length is often between 100 nm to 10 μm. However, the microfibrils may also be longer, for example between 10-200 μm, even lengths of 2000 μm can be found due to wide length distribution.

Fibers that have been fibrillated and which have microfibrils on the surface and microfibrils that are separated and located in a water phase of a slurry are included in the definition of MFC.

Furthermore, cellulose whiskers, microcellulose (MC) or nanofibrillated cellulose (NFC) are also included in the definition of MFC.

The fibrils may also be polymer coated fibrils, i.e. a modified fibril either chemically or physically, being thus either hydrophilic or hydrophobic. The fibrils may also be modified in any other way.

Nanofibrillated polysaccharides, such as microfibrillated cellulose (MFC) have many end uses. In the papermaking industry it can be added to the surface of a paper, or paperboard, or into the furnish. It has been shown that addition of MFC can increase the strength of a paper or board. When used in paper coating applications, it may replace synthetic binders, or natural binders such as latex and starch.

Microfibrillated cellulose (MFC) can also be used in the food industry. MFC can be used as a thickening agent and/or a water retention aid. It is then used as an additive to different food products due to its ability to change the rheology property of a food product, for example as an additive in ketchup or ice-cream. The MFC used has been approved as a food additive within the EU (E-460), by the WHO (World Health Organization) and generally world wide (e.g. INS 460 in Brazil).

Microficrillated cellulose (MFC) can also be used in many other technical fields—mainly used as an additive—in various areas such as polymers or plastics, paints, inorganic composites (e.g. plaster, cement), rubbers, cosmetics and pharmaceuticals.

Microfibrillated cellulose (MFC) can be produced in a number of different ways. It is possible to mechanically treat cellulosic fibers forming microfibrils. The production of nanocellulose or microfibrillated cellulose with bacteria, or fermentation, is another option. It is also possible to produce microfibrils from cellulose by the aid of different chemicals and/or enzymes which will break the interfibrillar bonds, or even dissolve the fibers and fibrills. One example of production of microfibrillated cellulose (MFC) is shown in WO2007091942 which describes production of MFC by the aid of refining in combination with addition of an enzyme.

The microfibrillated cellulose (MFC) of the solution according to the invention is preferably produced by at least partial enzymatic treatment of cellulosic fibers. The production of MFC may be done by combined enzymatic and mechanical/chemical treatments. During the production of MFC with enzymes, such as cellulase, hemicellulase, endoglucanase or mannase, the cellulosic fibers might be partly decomposed or released from the fiber matrix forming MFC.

The nanofibrillated polysaccharide, preferably the microfibrillated cellulose (MFC), of the solution according to the invention is in a food approved form, i.e. it is in a form that is approved for use in the food industry, i.e. it has an E-number.

The solution comprising microfibrillated cellulose may also comprise cellulosic gum, e.g. carboxy methyl cellulose (CMC), hydroxyethyl cellulose (HEC) or ethyl hydroxyethyl cellulose (EHEC). It has been shown that the combination of microfibrillated cellulose and cellulosic gum gives rise to better film forming properties, i.e. it is easier to create a thin but yet smooth and impermeable film in/on the food product.

The solution comprising microfibrillated cellulose may also comprise starch. The combination of starch and microfibrillated cellulose gives rise to an improved film with good strength and good smoothness.

It is also possible that the solution also comprises amphiphiles, such as lecithin. Solutions containing amphiphiles are of relevance for making protective solutions for fatty food products. It has been shown that the combination of nanofibrillated polysaccharide, preferably microfibrillated cellulose and lecithin will give fat containing food products good protection. The presence of lecithin or other amphiphiles will give food products with high fat contents good protection against degeneration.

The MFC of the solution preferably has a diameter of between 5-200 nm, more preferably between 5-100 nm. It has been shown that MFC within the mention length range has improved barrier properties, above all improved oxygen barrier properties, and will thus give the treated food product an improved resistance against oxygen reducing the degradation of the food product. If more than one layer of nanofibrillated polysaccharides are added to the surface of the food product, the layers may comprise nanofibrillated polysaccharides with different diameters, i.e. one layer may comprise a nanofibrillated polysaccharide with a given diameter and another layer may comprises a nanofibrillated polysaccharide with another diameter. It may be preferred to have nanofibrillated polysaccharides with a larger diameter closer to the surface of the product and nanofibrillated polysaccharide with a smaller diameter located in the outermost layer of the food product.

It is possible to add the solution comprising a nanofibrillated polysaccharide to the food product in many different ways. For some applications it is preferred to add the solution comprising a nanofibrillated polysaccharide by spraying, or brushing, the solution onto the surface of the food product. Spraying and brushing are fast methods and can easily be done on-line during for example the manufacturing process. It is thus possible to incorporate the treatment, according to the invention, as a step in an existing manufacturing chain. For other applications it might be preferred to add a larger amount of a nanofibrillated polysaccharide.

The most effective method for adding a larger amount of nanofibrillated polysaccharide is by soaking the food product by dipping the product into a solution with nanofibrillated polysaccharide. The best results with application to a meat product was achieved by soaking the product in a nanofibrillated polysaccharide solution. When the food product is soaked into the solution, it is possible to incorporate a large amount of nanofibrillated polysaccharide onto the food product. The nanofibrillated polysaccharide of the solution can both be located on the surface of the food product and it can be absorbed into the food product. Depending on the food product being treated, the time for which the food product is soaked into the solution comprising a nanofibrillated polysaccharide may vary. It is preferred that the food product is being soaked for a period of between 1 second to 48 hours, preferably for a period of between 1 minute to 12 hours. It is also possible to increase the pressure to above atmospheric pressure during soaking of the food product decreasing the time for the treatment as the treatment is much more efficient. It is also possible to add the solution by brushing the solution onto the surface of the food product, whereafter a over-pressure can be applied. The nanofibrillated polysaccharide solution can be made into foam that is then, preferably, sprayed onto the food product surface.

It may be preferred to treat the food product with a solution comprising a nanofibrillated polysaccharide in more than one step, preferably in two, three, four or even more steps. In this way it may be possible to increase the amount of nanofibrillated polysaccharide added to the product. It is also a way to ensure that a smooth layer or film is formed on the surface, i.e. the formed layer does not comprise any holes which would decrease the protection of the food product. It is also possible to use different solutions comprising various nanofibrillated polysaccharides for each treatments step. The solid content, the choice of nanofibrillated polysaccharide, eventual additives etc. may be different for the solutions in each treatment step. In this way it is possible to give each product the best possible protection against degeneration. It is possible to add the solutions to the product in different ways, preferably by the use of spraying, brushing, foaming and/or soaking of the product into the solutions. For example, a first solution may be sprayed onto the product followed by soaking the product into another solution. However, it is also possible to only add the solutions by spraying the nanofibrillated polysaccharide solution in liquid form or as a foam onto the surface of the food product, by brushing or soaking the product into the nanofibrillated polysaccharide solution.

Depending on which method used for addition of the solution comprising a nanofibrillated polysaccharide to a food product, the solid content of the solution may vary. It is preferred that the solution comprising a nanofibrillated polysaccharide has a solid content of 0.01-10% by weight. Lower consistency, i.e. solids content % by weight, generally results in a thinner film thickness. However, if the solution comprising a nanofibrillated polysaccharide is sprayed or added in the form of a foam onto the food product it is preferred that the solution comprising a nanofibrillated polysaccharide has a solid content of 0.01-1.5% by weight. If the food product is being brushed and/or soaked into a solution comprising a nanofibrillated polysaccharide the solution preferably has a solid content of 1-7% by weight. However, higher solid contents can also be used as long as it is possible to add the solution onto the food product in a good way.

It is also possible that the solution comprising a nanofibrillated polysaccharide further comprises an additive with preserving properties. Example of such additives are; calcium carbonate, acetic acid, potassium acetate, sodium acetate, calcium acetate, lactic acid, carbon dioxide, malic acid, ascorbic acid, sodium ascorbate, calcium ascorbate, fatty acid esters of ascorbic acid, tocopherol-rich extract, alpha-tocopherol, gamma-tocopherol, delta-tocopherol, lecithins, sodium lactate, potassium lactate, calcium lactate, calcium sulphite, sodium hydrogen sulphite, sodium metabisulphite, benzoic acid, calcium benzoate, calcium propionate, calcium sorbate, methyl p-hydroxybenzoate, potassium hydrogen sulphite, potassium metabisulphite, potassium nitrate, potassium nitrite, potassium propionate, potassium sorbate, sodium benzoate, sodium methyl p-hydroxybenzoate, sodium propionate, sodium sulphite and/or sorbic acid. There by we create a combined effect of the solutions preserving characteristics with the added preservative further increasing the shelf life of the product.

It is also possible to add seasonings and/or spices to the solution comprising a nanofibrillated polysaccharide. By treating a food product with the solution comprising both a nanofibrillated polysaccharide and seasonings it is possible to decrease the amount of seasonings needed since the seasonings tend to stay on the surface of the food product together with the nanofibrillated polysaccharides, e.g. a potentially gives a lower total sodium chloride (NaCl, i.e. table salt) content.

The present invention further relates to a food product treated with a solution comprising a nanofibrillated polysaccharide. It has been shown that a food product that has been treated with a solution comprising a nanofibrillated polysaccharide, preferably microfibrillated cellulose (MFC), has much longer shelf life, i.e. it shows less degradation, drying, etc. compared to products that have not been treated according to the invention.

The amount of nanofibrillated polysaccharide, preferably microfibrillated cellulose (MFC), on the food product is preferably 0.15-50 g/m². The amount of nanofibrillated polysaccharide added to the food product in order to achieve the necessary preservation properties depends on the food product being treated.

It is preferred that the nanofibrillated polysaccharide, preferably microfibrillated cellulose (MFC), forms at least one layer or a film on the surface of the food product. The layer being formed, preferably a film consisting of microfibrillated cellulose fibers, covers at least partly the surface of the food product and thus improves its shelf life and decreases decomposition of the food product. It is preferred that approximately 100% of the surface of the food item is covered by the layer consisting of nanofibrillated polysaccharide, i.e. the entire food product is being treated with the solution comprising a nanofibrillated polysaccharide and the entire food product is covered by a nanofibrillated polysaccharide layer.

It is preferred that the food product has been treated with a solution comprising microfibrillated cellulose and cellulose gum or starch. The food product will thus comprise a layer comprising both microfibrillated cellulose and cellulosic gum, e.g. CMC or a layer comprising both microfibrillated cellulose and starch. The layer or film located on the surface of the food product will have good strength properties, good smoothness and very thin and still giving the product improved resistance against degeneration.

It is also possible that the product has been treated with a solution that also comprises amphiphiles, such as lecithin. Solutions containing amphiphiles are of relevance for making protective solutions for fatty food products. It has been shown that the combination of nanofibrillated polysaccharide, preferably microfibrillated cellulose and lecithin will give fat containing food products good protection. The presence of lecithin or other amphiphiles will give food products with high fat contents good protection against degeneration. Example of such food products are marinated meat or vegetable products.

It is also possible that the food product comprises more than one layer of nanofibrillated polysaccharides on the surface of the food product. It is possible that each layer of nanofibrillated polysaccharides is identical to each other. However, it may be preferred that each layer of nanofibrillated polysaccharides differs from another. It is possible to use a different nanofibrillated polysaccharide in at least one of the layers, to add an additive to at least one of the layers, that at least one layer is a barrier etc. It is also possible to use nanofibrillated polysaccharides of different sizes in each layer. It is thus possible to customize the layers of the product in order to achieve the best possible protection against degeneration depending on the conditions during package and storage and also depending on the food product.

It is preferred that at least one of the nanofibrillated polysaccharide layers is a barrier giving the product protection against specific components. It is possible that the layer is a barrier against gases, preferably oxygen, preventing oxidization of the product. It is also possible that the layer is a barrier against moisture, preventing the moisture of the product from increasing or decreasing, thus preventing changes in the well-defined consistency of the food product for proper usage, taste and/or from destroying the food product.

It is preferred that the at least one layer of nanofibrillated polysaccharides has a thickness of above 1 μm, preferably above 10 μm. If more than one nanofibrillated polysaccharides layers are added to the product, it is preferred that the combined thickness of the layers is above 1 μm, preferably above 10 μm. The thickness of the layers may be measured by using microscopy, e.g. Scanning Electron Microscopy (SEM). The thickness of the at least one layer can differ depending on the method used for addition of the solution to the food product. Addition of the solution in the form of a foam may create very thin even films.

It is preferred that at least one of the nanofibrillated polysaccharide layers further comprises an additive with preserving properties. In this way it would be possible to further increase the shelf life of the product by adding an additive with preserving properties, such as a preservative or antioxidant.

It is also possible that at least one nanofibrillated polysaccharide layer further comprises a seasoning. By adding seasonings and/or spices to the solution comprising a nanofibrillated polysaccharide, the seasonings will thus be incorporated in the at least one nanofibrillated polysaccharide layer on the surface of the product. It has been shown that the seasonings to a larger extent stay on the surface of the product when it is added together with a nanofibrillated polysaccharide reducing the amount of seasonings needed. It is also possible to add different types of seasonings to different layers, e.g. salt to one layer and pepper to another layer. It is also possible that the solution comprises coloring ingredients. This may result in faster processing in a restaurant kitchen, i.e. increasing the capacity in food processing and making the food look tastier after processing.

The food product can be any type of eatable products such as meat, fish, seafood, bakery, bread, biscuit, fruit, vegetables or other perishables etc. The solution according to the invention can be added a to raw food product before eventual cooking. It can also be added during or after cooking of the raw food product, i.e. it can also be added to a cooked food product. Furthermore, the solution may also be added to a frozen food product.

### EXAMPLES

The nanofibrillated polysaccharide, i.e. microfibrillated cellulose (MFC) that was used in the solution was manufactured from never dried bleached pine pulp that was enzymatically pre-treated and thereafter mechanically treated. The produced MFC was added to a water solution in an amount so that the solid content of the solution was 1.1% forming the solution used in the examples below.

### Example 1

The effects of the treatment with a solution comprising MFC on chicken fillets were investigated.

Three chicken fillets were used; sample 1 was the reference sample and it was not subjected to any MFC solution, to sample 2 was 10 mL of the MFC solution added with a brush and sample 3 was soaked in the MFC solution for approximately 8 h. After treatment, the samples were left in room temperature. After 2 days the thickness of the chicken fillets were observed and it could clearly be seen that the reference sample had shrunk in thickness and that it had dried. It could be seen that sample 2 had dried less than the reference sample. Sample 3 was almost totally intact after two days in room temperature and it showed no severe shrinkage and it had remained soft texture.

### Example 2

The effects of the treatment with a solution comprising MFC on apples were investigated.

Three apples were used, sample 1 was the reference sample and it was not subjected to any MFC solution, to sample 2 was 10 mL of the MFC solution added with a brush and sample 3 was soaked in the MFC solution for approximately 8 h. After treatment the samples were left in room temperature. After 10 days, the degradation of the samples was investigated. The reference sample showed severe degradation but neither of the treated samples 2 or 3 showed any visual degradation either on the outside of the apples or on the inside.

Consequently, it is evident from the examples 1 and 2 that treatment of food products, in this case it was chicken fillets and apples, with a solution comprising of nanofibrillated polysaccharide, in this case microfibrillated cellulose (MFC), will preserve the food products and thus increases their shelf life.

In view of the above detailed description of the present invention, other modifications and variations will become apparent to those skilled in the art. However, it should be apparent that such other modifications and variations may be effected without departing from the spirit and scope of the invention.

1. Method for treating a food product wherein the food product is treated with a solution comprising a nanofibrillated polysaccharide in at least one step whereby the shelf life of the food product is increased.

2. The method according to claim 1 wherein the nanofibrillated polysaccharide is microfibrillated cellulose.

3. The method according to claim 2 wherein the solution further comprises cellulosic gum and/or starch.

4. The method according to claim 1 wherein the solution further comprises an amphiphile.

5. The method according to claim 1 wherein the solution is sprayed onto the surface of the food product.

6. The method according to claim 1 wherein the food product is soaked into the solution.

7. The method according to claim 6 wherein the food product is being soaked in the solution comprising a nanofibrillated polysaccharide for a period of 1 second-48 hours.

8. The method according to claim 1 wherein the food product is treated with the solution comprising a nanofibrillated polysaccharide in more than one step.

9. The method according to claim 1 wherein the solution comprising a nanofibrillated polysaccharide has a solid content of 0.01-10% by weight.

10. The method according to claim 1 wherein the nanofibrillated polysaccharide of the solution is produced by at least partly enzymatic treatment of cellulosic fibers.

11. The method according to claim 1 wherein the nanofibrillated polysaccharide of the solution has a diameter of between 5-200 nm.

12. The method according to claim 1 wherein the solution comprising a nanofibrillated polysaccharide further comprises an additive with preserving properties.

13. The method according to claim 1 wherein the solution comprising a nanofibrillated polysaccharide further comprises seasonings.

14. A food product treated with a solution comprising a nanofibrillated polysaccharide.

15. The food product according to claim 14 wherein the nanofibrillated polysaccharide is microfibrillated cellulose.

16. The food product according to claim 15 wherein food product has been treated with the solution that also comprises cellulose gum and/or starch.

17. The food product according to claim 14 wherein the food product has been treated with the solution that also comprises amphiphile.

18. The food product according to claim 14 wherein the nanofibrillated polysaccharide of the solution has a diameter of between 5-200 nm.

19. The food product according to claim 14 wherein the food product comprises nanofibrillated polysaccharide in an amount of 0.15-50 g/m².

20. The food product according to claim 14 wherein the food product comprises at least one nanofibrillated polysaccharide layer located on the surface of the food product.

21. The food product according to claim 20 wherein the food product comprises more than one nanofibrillated polysaccharide layers located on the surface of the food product.

22. The food product according to claim 20 wherein at least one of the nanofibrillated polysaccharide layers is a barrier.

23. The food product according to claim 22 wherein the barrier is an oxygen barrier.

24. The food product according to claim 20 wherein the at least one nanofibrillated polysaccharide layer has a thickness of above 1 μm.

25. The food product according to claim 20 wherein the at least one nanofibrillated polysaccharide layer further comprises an additive with preserving properties.

26. The food product according to claim 20 wherein the at least one nanofibrillated polysaccharide layer further comprises seasonings.
